(19) United States
(12) Patent Application Publication
(10) Pub. No.: US 2002/0009340 A1
(43) Pub. Date: Jan. 24, 2002

(54) Deep-hole drilling tool and method for manufacturing thereof

(76) Inventor: Bernd Nagel, Nuertingen (DE)

Correspondence Address: J. Rodman Steele, Jr., Akerman, Senterfitt & Eidson, P.A., Post Office Box 3188, West Palm Beach, FL, 33402-3188, US

(21) Appl. No.: 09/902,999

(22) Filed: Jul. 11, 2001

(30) Foreign Application Priority Data
Jul. 12, 2000 (DE) 10033874.7

(51) Int. Cl. B23B 51/00

(52) U.S. Cl. 408/144; 408/199; 408/226; 76/108.6

(57) ABSTRACT

In a method for the manufacture of a drilling tool a conical seat is constructed by abrasion on the drilling tool (11) for the preferably positionally accurate, oriented connection of drill head and drill shank. Abrasion preferably takes place by milling or erosion.

### BACKGROUND OF THE INVENTION

The invention relates to a deep-hole drilling tool and a method for manufacturing thereof.

Such deep-hole drilling tools mainly comprise a drill head and a drill shank, which are integrally interconnected at their front ends. The drilling tool is fixed in a sleeve, which is used for the transmission of the torque from the machine to the drilling tool. During drilling the drilling tool and consequently the junction point between the drill head and the drill shank is exposed to different forces, e.g. shearing forces, torsional forces, etc. It has therefore proved necessary to construct this junction point in a special way, so that it can withstand these forces.

DE 297 16 377 discloses a drilling tool, which substantially comprises the drill shank and drill head unit. The drill shank and drill head unit are integrally interconnected by planar contact faces formed at their front ends, e.g. by soldering. The connection can also be brought about by means of an adaptor, e.g. a disk-shaped intermediate part. The end faces on the drill head unit and drill shank are connected to the end faces of the intermediate part.

### OBJECT OF THE INVENTION

An object of the invention is to provide a method for manufacturing a drilling tool in a simple and inexpensive manner. Another object is to obtain a drilling tool, which is stable and reliably usable in all conceivable fields.

### BRIEF DESCRIPTION OF THE INVENTION

According to the invention the seat between drill head and drill shank is constructed conically for a positionally accurate and oriented or mutually aligned connection of the drill head and the drill shank.

In the sense of the present invention the term drilling tool is used to mean all deep-hole drilling devices, also called gun drilling tools, such as bits and the like usable for deep drilling and which essentially comprise a drill head and a hollow drill shank.

The conical construction of the seat offers the advantage that on the one hand it can be rapidly and inexpensively manufactured, e.g. by milling and secondly acts in a self-centring manner, so that the drill head and drill shank can always be oriented in positionally accurate and aligned manner with respect to one another. As a result during drilling undesired shearing forces strongly stressing the drilling tool do not occur, as would arise with a non-aligned arrangement of the drill head and drill shank. Compared with a straight, frontal connection, the conical seat of the drill shank and drill head has an enlarged contact face, so that a more stable connection is obtained.

As stated, the conical seat can be manufactured by milling. The preferred milling method is high speed milling. It is e.g. possible to use a HSC milling machine, whose spindle and the milling head fixed thereto rotates at a frequency of 16,000 to 24,000 revolutions per minute. The feed rate can range between 10 and 30 m/minute. The conical seat is preferably produced by circular or slab milling and an e.g. also conically constructed milling head rolls on the drilling tool.

Another method for manufacturing of the conical seat is erosion, particularly spark erosion. In spark erosion the drilling tool is positioned as the workpiece electrode in a preferably non-conductive liquid (dielectric). The seat is then produced by the shaping tool electrode of the spark erosion machine complimentary to the workpiece electrode. The shaping tool electrode is imaged in the workpiece electrode, i.e. in the drilling tool. During erosion only the tool electrode of the spark erosion machine is moved, whereas the drilling tool is positioned accurately in the liquid. This makes it possible to produce a uniform, precisely constructed seat

In comparable machining methods, such as turning or grinding, the workpiece to be machined is fixed and preferably performs a rotary movement. As a result of unbalances in the workpiece, particularly due to its asymmetrical cross-section resulting from the crease or bead, oscillation takes place, so that a uniform construction of the seat is either impossible or only possible with very considerable difficulty. During grinding it is e.g. necessary to frequently carry out dressing as a result of grinding wheel wear in order to produce a precisely fitting seat. In addition, the grinding rate is not precisely the same at all points of the drilling tool, so that differently machined areas arise. Particularly in the case of standard drilling tools with an inner crease with radial sides there is a difference between the grinding rate at the radial sides from that on the drilling tool circumference and tends towards zero in the centre (crease). Compared with turning or grinding in the case of milling or spark erosion the working times are much shorter and only last a few minutes.

Thus, the method according to the invention is characterized in that the seat is conically manufactured on drilling tools made from different materials. For the manufacture thereof by abrasion, particularly by milling or erosion, a relatively short machining time of a few minutes is needed, but it is possible to construct the seat more precisely and uniformly than e.g. by turning or grinding.

The seat surface is preferably made rough during milling or erosion. During milling the roughness is attributed to milling marks or grooves left behind by the milling head of the milling machine. In the case of erosion the surface can even be micro-rough, corresponding to fine sand blasting. It can have rib or tooth systems. Particularly when soldering the drill shank and drill head, said milling marks or rib or tooth systems form a good hold for the solder material.

Preferably, in the method according to the invention, the seat is manufactured first, then the drill head is mounted on the drill shank and is integrally joined thereto, preferably by brazing.

For joining the drill head and drill shank it is possible to use all known joining methods, such as welding, soldering, etc., but the seat is preferably brazed.

The seat can be manufactured both on the drill shank and on the drill head, but it is preferably constructed with the method according to the invention on the drill shank. The drill shank is preferably a hollow section, particularly a profile tube with an inner crease, which is used for removing the chips produced during drilling and for the supply of coolant, particularly cutting oil. If said hollow section-like drill shank with the inner crease was machined by turning or grinding, during the rotary movement performed during the working process it would oscillate, so as to make more difficult a uniform machining of the seat. However, in the case of milling the milling head rotates and the drilling tool is fixed. There is also no rotation of the drilling tool with spark erosion, so that it is possible to accurately and uniformly machine non-rotationally symmetrical, hollow section-like drill shanks.

In the method according to the invention it is possible to construct a preferably conical counterpart on the drill head complimentary to the seat in the drill shank. The counterpart could also be produced by turning or grinding, but it is preferably also milled or eroded, which leads to a rough, particularly microrough surface of the drill head. A method according to the invention, particularly erosion is particularly appropriate if the drill head is made from hard metal or carbide.

In the method of the invention for the manufacture of the drilling tool it is possible to use all materials suitable for drilling, particularly deep drilling, such as steel, e.g. high speed steel and the like, which can be milled or eroded. However, the seat is preferably milled or eroded in a carbide drilling tool.

The deep-hole drilling tool is provided with an at least partly conical seat, which is part of an integral connection or joint between drill head and drill shank. The seat can be produced by milling, particularly high speed milling, or by erosion, particularly spark erosion. The seat is be provided on the drill shank or on the drill head, i.e. the counterpart complimentary to the seat is also conical. Preferably the seat is formed in the drill shank by the end face of the wall thereof. The end face of the drill shank, corresponding to that of the head, can be formed corresponding to the cross-section the of the profile of the hollow shank as an arcuate segment, the ends of which are connected to two radial, interconnected segments, running towards the drilling axis.

Preferably the conically constructed end face of the drill shank is inclined to the drilling axis. The included angle between the end face and the outer face of the drill shank can be 10° to 50°, particularly 20° to 40°. The invention is especially useful for single-lip deep-hole drilling tools, having only one cutting edge at their head.

The surface of the seat is preferably rough, e.g. through milling marks resulting from the milling operation or rib or tooth systems resulting from the erosion operation, especially cones or craters. The tooth systems can e.g. be constructed as Hirth-type serrations having interconnecting teeth. The formation of craters is typical with spark eroded surfaces and arise due to the discharge of both electrodes, i.e. the tool electrode and the drilling tool.

Thus, the drilling tool according to the invention is characterized by a self-centring, conical seat in the drill shank. As a result the drill head and drill shank can always be oriented in alignment with one another, so that no unbalances can arise during drilling, which could cause wear of the drive motor or even a breaking off of the drilling tool. The surface of one or both seats is covered with marks, grooves or craters due to milling or erosion, which leads to an improved hold of the solder material and consequently a more stable connection between drill shank and drill head than with comparable machining methods, such as turning or grinding. Thus, the drilling tool according to the invention is reliably usable even under the toughest drilling conditions.

These and further features can be gathered from the claims, description and drawings and the individual features, either singly or in the form of sub-combinations, can be implemented in an embodiment of the invention and in other fields and represent advantageous, independently protectable constructions for which protection is claimed here. The subdivision of the application into individual sections and the subtitles in no way restrict the general validity of the statements made thereunder.

### BRIEF DESCRIPTION OF THE DRAWINGS

The method according to the invention for the manufacture of a drilling tool and an embodiment of the drilling tool are described hereinafter relative to the attached drawings; wherein show:

FIG. 1 The drill shank during erosion in an eroding machine.

FIG. 2 A three-dimensional view of the drill shank and drill head.

FIG. 3 A side view and cross-section of the drill shank.

FIG. 4 A side view and cross-section of the drill head.

FIG. 5 The drill head and drill shank immediately prior to fixing together.

FIG. 6 The drill head and drill shank after fixing together.

FIG. 7 The method sequence of the manufacturing or joining process of drill shank and drill head.

FIG. 8 The drill shank on milling in a diagrammatically represented milling machine.

### DESCRIPTION OF A PREFERRED EMBODIMENT OF THE INVENTION

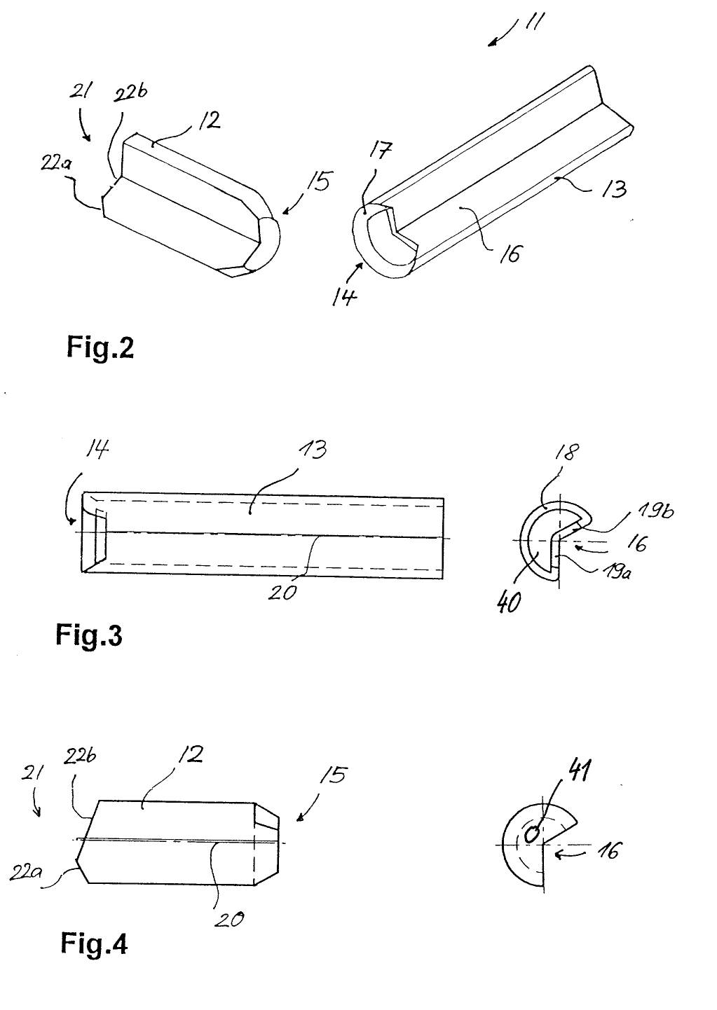

The deep-hole drilling tool 11 shown in FIG. 2 essentially comprises a drill head 12 and a drill shank 13. The drill head 12 is a solid section rod, from which the inner crease 16 has been removed in the manner of a piece of tart (cf. FIGS. 2 and 4). One end of the drill head 12 is constructed as a drill head tip 21. The drill head tip 21 has a secondary cutting edge 22b inclined to the drilling axis 20 and a main cutting edge 22a running in one plane and at an angle of approximately 120° to the secondary cutting edge 22b. Such deep-hole drilling tool are called single-lip deep-hole drilling tools. The cutting edges 22a, 22b meet one another eccentrically to the drilling axis 20, accompanied by the formation of a tip 21. The end of the drill head 12 opposite to the drill head tip 21 has a conical construction and forms a counterpart 15 complimentary to the seat 14 on the drill shank 13. The counterpart 15 is produced by erosion, milling, turning or grinding. The conicity of the counterpart 15 can e.g. be formed by a chamfering process during circular grinding.

The drill shank 13 is a profile tube with a circular segmental recess as the inner crease 16 and which extends up to the centre of the tube (cf. FIGS. 2 and 4). The inner crease 16 is used for removing chips from the drilling zone, while the inner channel 40 formed by the hollow shank is used for supplying cutting oil to the drilling zone. At one end the drill shank 13 has a conically constructed seat 14. The seat 14 is formed by the end face 17 of the drill shank 13. Corresponding to the cross-section of the drill shank 13 the end face 17 comprises an arcuate segment 18 with in each case two radial, interconnected segments 19a, 19b, running towards the drilling axis 20, and connected at one end of the arcuate segment 18. The seat 14 in the drill shank 13 is produced by milling or erosion, as will be described in greater detail hereinafter. The ratio of the shank diameter to the shank length is 1:15 to 1:250, particularly 1:30 to 1:100. The end face 17 constructed as seat 14 is inclined at an angle of 30 10 to the drilling axis 29.

The drill head 12 is made from hard metal or carbide and cut to length from a solid section blank, or, preferably from an already tart-shaped profile. Then, if necessary, in the drill head 12 the inner crease 16 is produced by milling out a circular segmental portion and other shaping of the tool head for its use is performed. The drill shank 13 is cut to length from a hollow section blank of steel. The inner crease 16 can e.g. be produced by countersinking or punching in a steel tube, but it is also preferred to use a already tart-shaped hollow profile tube and cut it to the desired length. For drilling purposes the drilling tool 11 comprising the drill head 12 and drill shank 13 is fixed in a not shown clamping sleeve, which serves to transmit the torque from the motor to the drilling tool 11. The tool is guided in a guide sleeve and connected with its channel 40 to a supply of drilling liquid or oil, which is lead from the channel 40 to the drilling zone by a hole 41 in the drill head. The drilling liquid and chips machined by the tool are flowing out of the resulting bore through the channel formed by the crease 16.

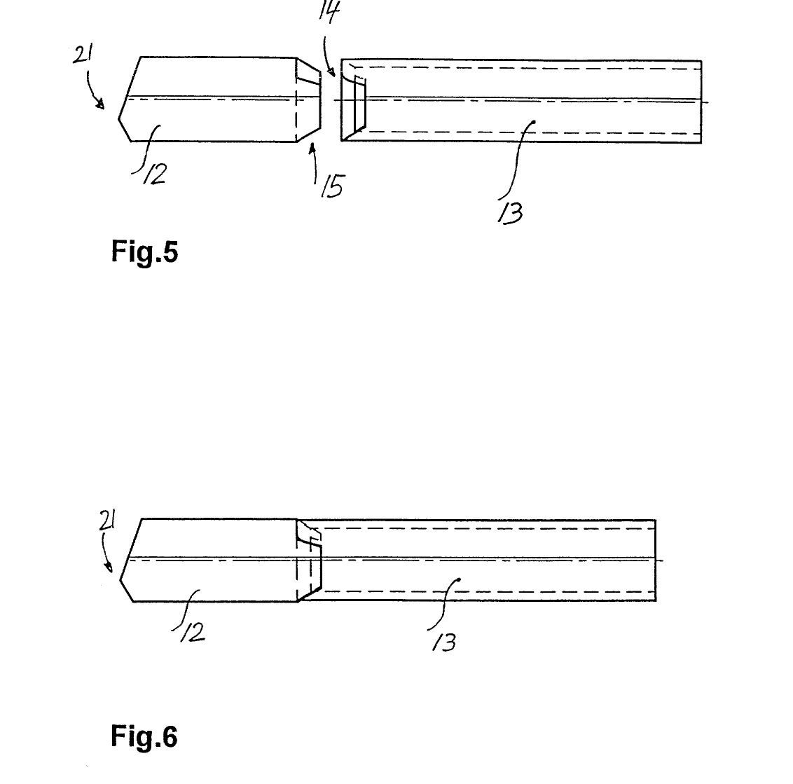

For joining the drill head 12 and drill shank 13 the conical seat 14 on the drill shank 13 and the conical counterpart 15 on the drill head 12 are fixed together (c. FIGS. 5 and 6). Preferably brazing is used as the joining process and this e.g. takes place through the use of a soldering ring placed in a not shown soldering gap.

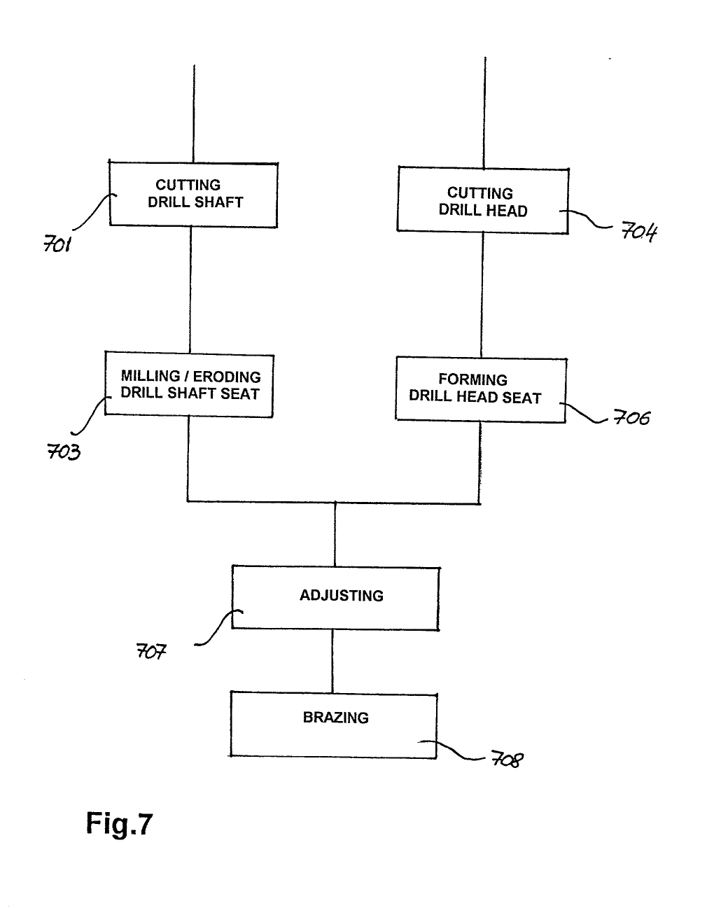

According to the method sequence shown in FIG. 7 the drill head 12 and drill shank 13 are cut to length from tart-shaped profiles of hard metal and steel tube material, resp. (steps 701 and 704). Then on the drill shank 13 the drill shank seat surface 14 is milled out or eroded as a conical surface (step 703) and on the drill head 12 the matching counterpart, the drill head seat surface 15, is formed by grinding, milling or eroding (step 706). The drill shank 13 and drill head 12 are then oriented in positionally accurate manner to one another (step 707), which is easy because of their conical shape seat surfaces and finally joined by an integral joint which means brazing (step 708) or any other joint connecting two surfaces by an inter-metallic or inter-material connection including welding and gluing.

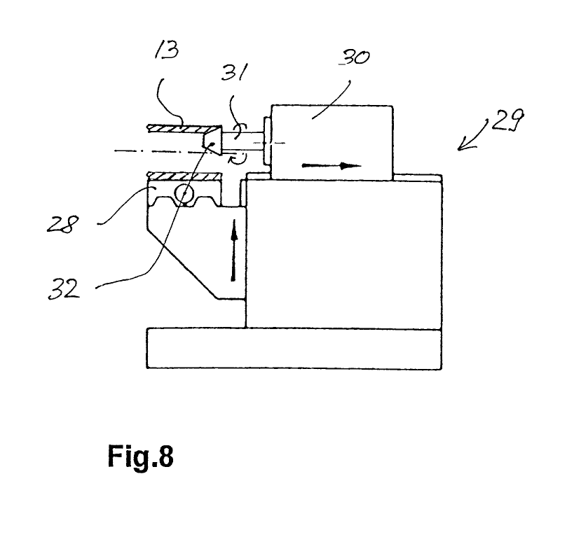

The seat 14 on the drill shank 13 can be produced by high speed milling. As shown in FIG. 8, the drill shank 13 is initially brought onto a vertically movable worktable 28 of a milling machine 24 in the working position. The milling machine used is e.g. a horizontal knee-type milling machine with horizontally movable headstock 30 usable for high speed milling purposes. The milling machine spindle 31 is rotated and the conically constructed milling head 32 is introduced into the drill shank 13. The spindle 31 also performs a not shown rotary movement, so that the rotating milling head 32 rolls on the inner wall of the drill shank and forms the conical seat 14.

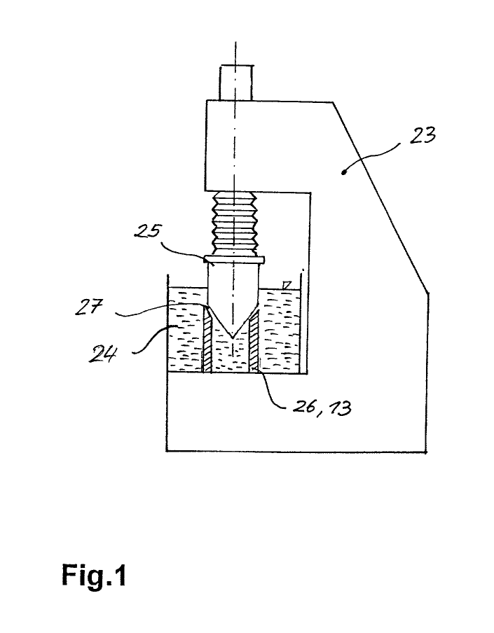

Another method for the manufacture of the drill shank is spark erosion. As shown in FIG. 1, the drill shank 13 is initially introduced into an electrolytic bath 24 of an eroding machine 23. The electrodes used are the drill shank 13 and the tool 25, also referred to as a spindle sleeve, of the eroding machine 23. The drill shank 13 and tool 25 are brought in the working position in such a way that an eroding gap 27 is left between them. If a voltage is now applied to the electrodes, on exceeding the dielectric strength of the working medium, predetermined by the electrode spacing and the conductivity of the dielectric, i.e. the electrolytic bath, formation takes place of an energy-rich plasma channel between the drill shank 13 and spindle sleeve 25. During erosion the conical spindle sleeve 25 is formed in the drill shank. The discharges at the electrodes produce on the drill shank surface craters, whose lining up or superimposing lead to the trough-shaped surface structure typical of eroded workpieces without oriented machining marks.

1. Method for manufacturing of a deep-hole drilling tool (11) having a drill head (12) and a hollow drill shank (13) connected to each other at a seat including a drill head seat surface (15) at the drill head and a shank seat surface (14) at the drill shank, both seat surfaces are made conical and being connected to each other by an integral joint.

2. Method according to claim 1, wherein the seat is produced by milling.

3. Method according to claim 2, wherein the seat is produced by high speed milling.

4. Method according to claim 1, wherein the seat is produced by erosion.

5. Method according to claim 4, wherein the seat is produced by spark erosion.

6. Method according to claim 1, wherein during the production of the seat at least one of the surfaces of the seat is made rough.

7. Method according to claim 6, wherein at least one of the surfaces (14, 15) of the seat comprise indented structures.

8. Method according to claim 6, wherein during the production of the seat the surface of the seat is made micro-rough.

9. Method according to claim 1, wherein the shank seat surface (14) includes conical surface portions corresponding to the hollow drill shank (13) having a tubular profile including a fluid channel (40) with a outer wall having a circular section, which is circular around a drilling axis (20), the wall further having a crease (16) extending from the outer wall towards the axis and forming a further fluid channel.

10. Deep-hole drilling tool (11) provided to be rotated around a drill axis (20), the tool having a drill head (12) and a hollow drill shank (13) connected to each other at a seat including a drill head seat surface (15) at the drill head and a shank seat surface (14) at the drill shank, both seat surfaces are conical and connected to each other by an integral joint, whereby the drill head (12) and the drill shank (13) are positionally accurately oriented in relation to the drilling axis.

11. Drilling tool according to claim 10, wherein at least one of the surfaces of the seat includes ribs

12. Drilling tool according to claim 10, wherein at least one of the surfaces (14,15) of the seat are rough as a result of craters formed during erosion of this surface.

13. Drilling tool according to claim 10, wherein the seat (14) is provided in a hollow section-like drill shank (13) having an inner crease (16) and in which on the drill head (12) is provided an in particular conical counterpart (15) complimentary to the seat in the drill shank.

14. Drilling tool according to claim 13, wherein the drill shank seat (14) is an end face (17) of the hollow drill shank (13).

15. Drilling tool according to claim 10, wherein the shank seat surface (14) includes conical surface portions corresponding to the hollow drill shank (13) having a tubular profile including a fluid channel (40) with a outer wall having a circular section, which is circular around the drilling axis (20), the wall further having a crease (16) extending from the outer wall towards the axis and forming a further fluid channel.

16. Drilling tool according to claim 13, wherein the seat (14), is conical with an included angle of 20° to 40° to the drilling axis (20).

17. Drilling tool according to claim 10, wherein the tool is a single-lip deep-hole drilling tool.
